(19) United States
(12) Patent Application Publication
(10) Pub. No.: US 2022/0234550 A1
(43) Pub. Date: Jul. 28, 2022

(54) PORTABLE VEHICLE WASHING SYSTEM AND METHODS

(71) Applicant: Robert Witt, Camp Verde, AZ (US)

(72) Inventor: Robert Witt, Camp Verde, AZ (US)

(21) Appl. No.: 17/581,878

(22) Filed: Jan. 22, 2022

Related U.S. Application Data
(60) Provisional application No. 63/142,658, filed on Jan. 28, 2021.

(51) Int. Cl. B60S 3/04; C02F 1/44; C02F 1/00; B01D 61/02; B01D 61/08; B01D 61/04; B01D 61/12; B05D 5/00; B05D 3/12; D06F 29/00; D06F 39/08; B24B 23/02; C09G 1/02

(52) U.S. Cl. CPC B60S 3/04; B01D 2313/18; C02F 1/001; B01D 61/025; B01D 61/08; B01D 61/04; B01D 61/12; B05D 5/00; B05D 3/12; D06F 29/005; D06F 39/088; B24B 23/02; C09G 1/02; C02F 2201/008; C02F 2201/005; B01D 2313/243; B01D 2311/04; B01D 2311/2649; C02F 2209/42; C02F 2209/03; B01D 2311/14; C02F 1/441

(57) ABSTRACT

Devices, methods and systems are provided for preserving the surface of vehicles. The system includes a mobile housing such as a pull behind trailer that contains a purified water storage tank, a clothes washer and drier, a water heater, a multimedia filtration system, a Reverse Osmosis (RO) System, a discharge pump, and a booster pressure pump. Smaller satellite tank trailers may be serviced by larger system described herein to allow simultaneous washings. A high concentration SiO2 ceramic coating is applied with SiO2 concentration ranging between 49.9% and 64.1%.

### RELATED APPLICATIONS

The present utility application claims benefit from provisional application 63/142,658 that was filed on Jan. 28, 2021.

### TECHNICAL FIELD

The present subject matter generally relates to vehicle washing and preservation systems and methods, and more specifically to a self-contained mobile detailing apparatus with a washing system that includes a water storage tank, a centrifugal tank discharge pump, a supply side multimedia filter, reverse osmosis subsystem, a washing machine and dryer for processing wipe down towels, and a heater which heats water for the washing machine. The systems and methods also includes a method for preserving the exterior of a vehicle with windows that involves the application of a high SiO2 concentration ceramic coating to provide ceramic protection layer with a 9H hardness level on a 0-10 lead hardness scale.

The apparatus is wholly contained in a tow-behind box trailer or in a panel truck of similar size. It is designed to be parked in an existing RV space and provide service for an entire RV Park from the space. This system may be used on vehicles directly or may service smaller satellite units that can disperse across a larger area to do multiple washings/preservations simultaneously. The subject matter contained herein includes the use of a silicon dioxide formulation that preserves and seals the painted vehicle body but also adheres and seals the silicone window caulking, the deterioration of which is a well-known problem resulting a debilitating weathering effect on the vehicle and the value thereof.

### BACKGROUND

It is very difficult and time consuming for an owner of a recreational vehicle (RV) or a mobile home to properly maintain the exterior of the vehicle. This is particularly the case where a location has hard water from the tap. In Arizona, for example, by the time the all sides of the RV are rinsed the side onto which the hard rinse water was first applied has dried leaving hard water spots that are unsightly and make it exponentially more difficult to properly apply a protective ceramic coating. The end result of a wash is that the owners replace dirt and dust with water scale on the outside of the vehicle.

Using water from an RV's water softener, if the RV is so equipped, is impractical and does not provide the volume of water needed to wash the RV. Further, water is heavy and towing the required volume of water from sources outside an RV park is costly and hard on the equipment. This self-contained apparatus and service is mobile and designed to be towed to existing RV spaces and provide everything necessary to maintain the exterior of an RV so the park owners can provide their guests with needed service. The system may be mounted in any of a pull behind trailer, a panel truck, a cargo shipping container, a moving pod, and the like.

Furthermore, merely washing a vehicle with soft water is insufficient to preserve the exterior of the vehicle from oxidation. Both paint and the silicone weather caulking around the vehicle's windows oxidizes and deteriorates over time, particularly in the in the harsh weather of the American Southwest. Such deterioration and oxidation shortens the useful life of the vehicle and the resale value thereof.

The use of a commercial grade silicon dioxide (SiO₂) sealant for the exterior of the vehicle has proven ineffectual and its protective benefits fleeting. This is particularly true of the caulking around the vehicle windows and the junction between the seal and the metal vehicle siding panels. Standard commercial grade SiO₂ sealants, and their application methods, tend to bond poorly in these junctions resulting in the cracking and peeling of the sealant that results in the resumption of accelerated deterioration. Hence, new systems and methods for vehicle cleaning and preservation are desirable.

### BRIEF SUMMARY

Devices, methods and systems are provided for efficiently washing vehicles such as RV's, utility trailers and mobile homes. An exemplary system includes a mobile housing such as a pull behind trailer that contains a heated supply line that connects to a water supply a purified water storage tank, a clothes washer and drier, a water heater, a multimedia filtration system, a Reverse Osmosis (RO) System, a discharge pump, and a booster pressure pump. Methods are provided for the novel use of very high silicon oxide ceramic coatings to produce superior hardness finishing.

A method for preserving the exterior of a vehicle with glass windows is provided. The method comprises washing the exterior of the vehicle with reverse-osmosis water, drying the exterior, applying a ceramic coating material to the exterior, wherein the ceramic coating material has a silicon oxide (SiO2) concentration of greater than 43%, and buffing the ceramic coating with a dual action buffing device.

A mobile washing system kit is provide, comprising a multi-media filter, a valve enclosure, a booster pump with a rated discharge pressure between 100 psi and 400 psi, a reverse osmosis (RO) system, an RO storage tank with a capacity greater than 100 gallons, a high pressure discharge pump, at least one high pressure nozzle, a washing machine, a clothes drier, a dual action orbital buffing device, and a power distribution system configured to delivering power from a power source to the valve enclosure, the booster pump, the high pressure pump, the washing machine and a clothes drier.

### BRIEF DESCRIPTION OF THE DRAWINGS

The present invention will hereinafter be described in conjunction with the following drawing figures, wherein like numerals denote like elements.

FIG. 1 is perspective view of an exemplary tow-behind trailer that may be used to house and transport the system components described herein;

FIG. 2 is a perspective view of the water receiving and processing subsystem.

FIG. 3 is a perspective view of the electrical distribution system and water heater.

FIG. 4 is a plan view of the water receiving and processing system.

FIG. 5 is a process flow chart for preserving the surface of a vehicle.

FIG. 6 is a non-limiting example of a dual action orbital buffer.

### DETAILED DESCRIPTION

The following detailed description is merely exemplary in nature and is not intended to limit the invention, or the application, or uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description. Any express dimensions mentioned herein are exemplary only and are not intended to be limiting.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. Process steps may be interchanged in any order without departing from the scope of the invention as long as such an interchange does not contradict the claim language and is not logically nonsensical.

Depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

In the following description, reference is made to a “ceramic coating.” Ceramic coatings herein may be silicon dioxide, titanium dioxide and similar substances. Although not intended to be so limiting, for the sake of clarity and brevity the term “ceramic” herein will refer to silicon dioxide (“SiO2”).

In the industry, to state that one's product is a ceramic protection product, the product must contain a minimum amount of SiO2 in at least the 2-3% range, as is present in some vehicle “ceramic waxes.” As opposed to low quality ceramic wax applications, the use herein of the terms “ceramic” or “ceramic coatings” refers to high SiO2 concentration products with SiO2 concentrations over 43%. For example, NextGen global LLC offers ceramic protection products in the SiO2 30% to 43% range. However, processes herein discuss the use of higher concentration ceramic coating protection using proprietary formulations with SiO2 levels in the unconventional range of 50% to 64% (inclusive).

References to “clay bar” used herein refer to a clay or putty like material that is commonly used is the cleaning of a vehicle paint surface. As a non-limiting example “clay bar” may comprise hydrolyzed aluminum phyllosilicate (Al2SiO2O5(OH)4). Clay bar may also be used in small quantities in “clay bar lubricant” products.

References herein to a “hardness” or a “hardness scale” refer to the well-known graphite or “pencil lead” HB hardness scale that ranges from 9H on the hard end of the scale to 9B on the soft end of the scale.

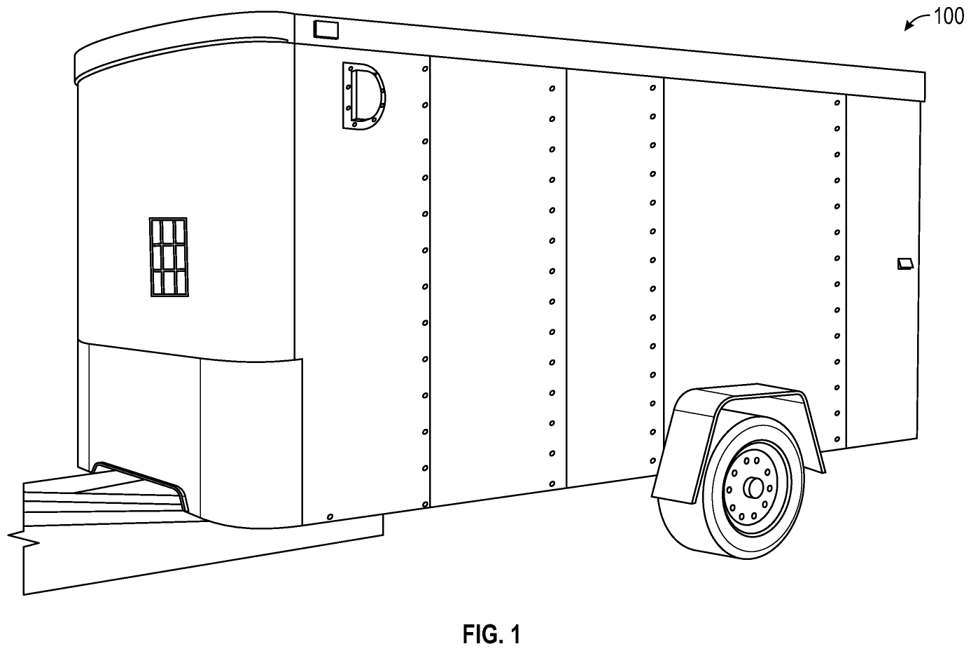

FIG. 1 is a perspective view of an exemplary tow-behind trailer that may be used to transport and house the system and components described herein. Alternatively a panel truck may also be used. The size of the trailer is optional and depends primarily upon the volume of the storage tank used. Herein, a one thousand (1,000) gallon storage tank is discussed. However, a different sized tank may be used. The tank may be an open tank or a closed pressurized tank.

It is contemplated herein, that smaller, satellite trailers may be supported by a main trailer with a large main storage tank. The satellite trailers may or may not have a RO system. In this instance the main trailer may take on and process clean RO wash water. The main trailer may then resupply clean wash water to the multiple satellite trailers.

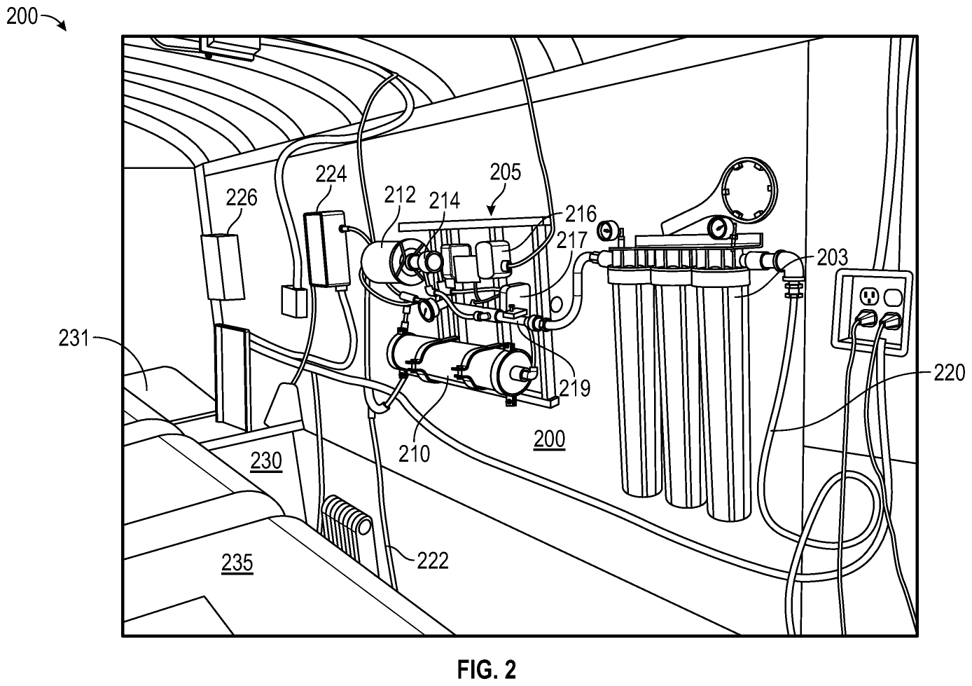

FIG. 2 is a perspective view of the water intake and processing system 200, which in this exemplary embodiment services a 1000 gallon storage tank 235. Tap or well water is brought into the processing system via intake line 220 at whatever pressure the outside water system provides and fed through multimedia filter(s) 203. As the name suggests the three multimedia filter(s) 203 shown each have a different filter media. As an example, a multimedia filter may contain three layers of media consisting of activated charcoal, sand and garnet to remove suspended solids. In some embodiments removal of solids greater than 5 microns is adequate. Activated charcoal is adept at removing chlorine.

The discharge from the multimedia filters is coupled to a switch housing 219 through an inlet solenoid switch 217 that shuts the water inlet to the pump when the system is not in service. The switch housing 219 may contain a tank high pressure switch and a tank level float switch 216. The tank high pressure switch is only relevant when working with a closed tank embodiment. With an open tank the high pressure set point is never reached.

In order to insure sufficient input pressure into the RO system 205, the filtered water is fed to a booster pump 214 that is driven by electric motor 212. The booster pump may be a rotary vane type pump with an output pressure of 150-300 psi.

The RO discharge line 222 may split to supply both the washing machine 230 and storage tank 235. Water for the washing machine 236 may be preheated by an electric heater 224. A clothes dryer 231 may also be included. Washer 236 and dryer 231 are used to clean and recycle washing cloth or shammies.

The RO water stored in tank 235 is discharged outside the trailer 100 by a floor mounted pump (not shown) through a flexible hose (not shown). The floor mounted pump may be a positive displacement pump or a centrifugal pump.

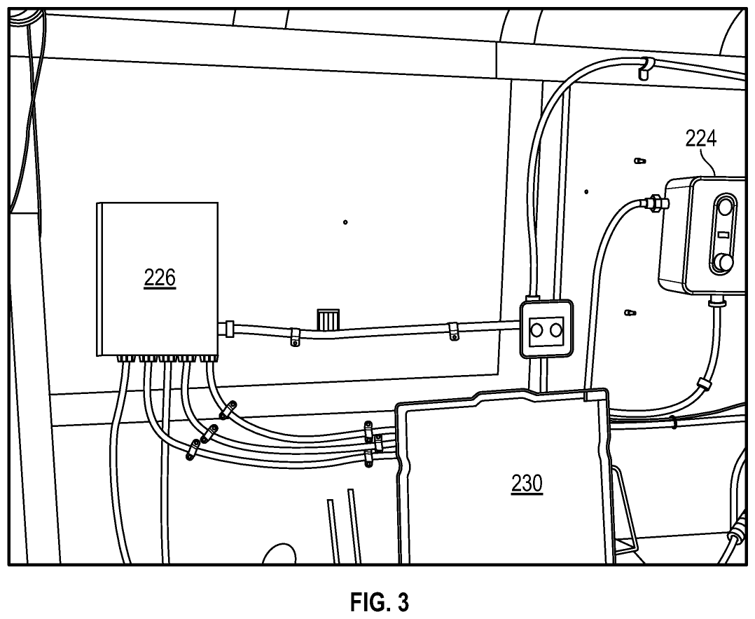

FIG. 3 is an exemplary 50 amp electrical distribution system. Distribution box 226 may be any suitable distribution system. In some embodiments the distribution system receives 50 amp street power and distributes to all of the subsystems discussed above.

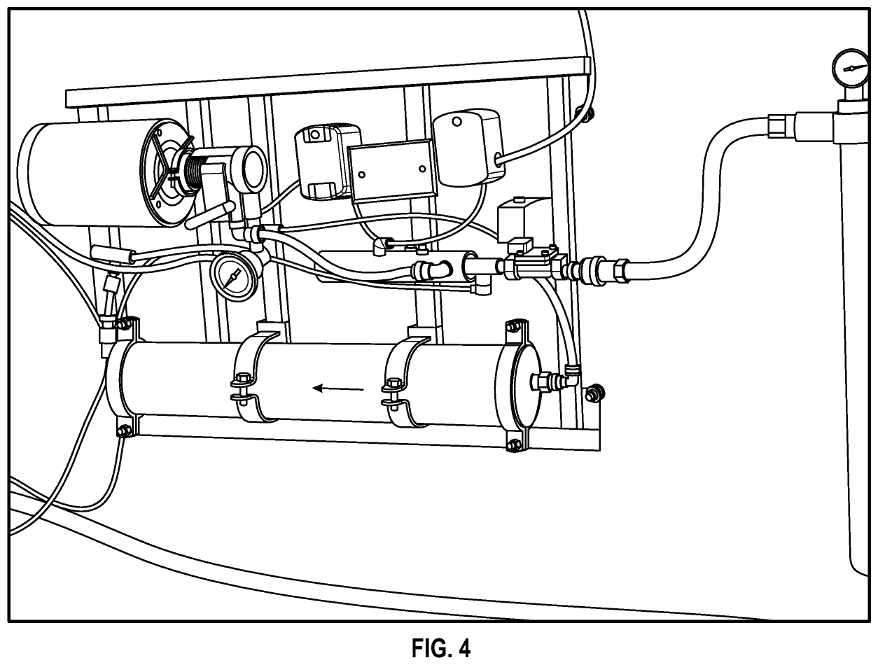

FIG. 4 is a second view of the water intake and processing system 200.

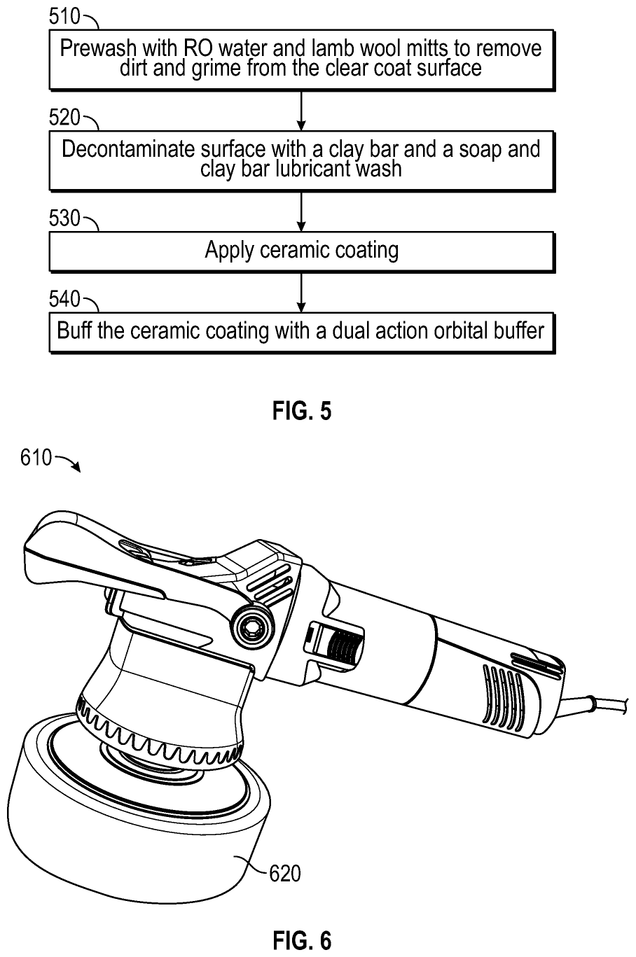

FIG. 5 is a process flow diagram for an exemplary method for preserving the surface of a vehicle. At process 510, the entire vehicle is washed then rinsed with RO water and dried with clean towels or shammies cleaned in the washer 230 and drier 231. This is a prewash to remove dirt, grime and dust. As a first wet down, RO concentrate generated and collected from the RO system 205 may be used as an economy measure with the final rinse being accomplished with RO water from tank 235. A clay bar wash uses a lubricant and clay bar to remove materials from the surface. The clay bar used is a 3M product and is an adhesive material that sticks to anything on the surface of the exterior finish removing impurities from the surface to provide the best possible finish in preparation for the Ceramic Coating A clay bar is a putty or clay like substance that is gently rubbed over a clear coat surface to remove unseen dirt particles, overspray and other surface contaminants that have adhered to the clear coat. A non-limiting example of a clay bar lubricant is “Prowash” that contains liquid clay bar and a lubricating soap, which can be obtained from Big Mike's Extreme at Bigmikesproducts.com

At process 530, a high SiO2 concentrate ceramic coating is applied to the cleaned vehicle surface, window frames and silicone seals. Conventional ceramic coatings typically contain a SiO2 concentration below 43% and contain activation chemicals and curing agents. However, the ceramic coating material disclosed herein has a SiO2 concentration of at last 50% and can extend to 64% without adverse performance. It is also preferable that the ceramic coating not contain activation chemicals or curing agents as are found in some commercial products.

At process 540, the ceramic coating is buffed with an orbital electric buffer 610 (see FIG. 6) using lamb's wool buffing pads 620. A 360° rotating buffer (with or without a second vibration feature) will provide sufficient friction alone to harden the high concentration ceramic coating to a 9H hardness on a graphite hardening scale, thereby making curing agents or activation chemicals unnecessary. The rotation speed of the lamb's wool buffing pad 620 is preferably 1100 RPM and is preferably applied in combination with longitudinal progression speed of approximately four (4) inches per second. The speeds disclosed here in are exemplary and non-limiting. It would immediately occur to those skilled in the art that combinations of different RPM and different longitudinal progress speeds may also be used that would result in similar friction levels producing similar hardness results.

It should also be noted that the while high concentration ceramic coating material can and should be used on the window frames/jams and the silicone seals thereof, it should not be applied to the window glass as it may impair visibility through the glass. Instead a lower SiO2 concentration spray of no more than 17% should be used.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1) A method for preserving the exterior of a vehicle with glass windows, comprising:
washing the exterior of the vehicle with reverse-osmosis water,
drying the exterior,
applying a ceramic coating material to the exterior, wherein the ceramic coating material has a silicon oxide (SiO2) concentration of greater than 43%, and
buffing the ceramic coating with a dual action buffing device.

2) The method of claim 1, where the ceramic coating applied to the vehicle exterior has a silicon oxide (SiO2) concentration of greater than 50%.

3) The method of claim 1, where the ceramic coating applied to the vehicle exterior has a silicon oxide (SiO2) concentration of between 49.9% and 64.1%.

4) The method of claim 1 wherein a ceramic spray is applied to the glass windows instead of the ceramic coating, the ceramic spray having a SiO2 concentration of no more than approximately 17%.

5) The method of claim 1, wherein the dual action buffing device is an orbital buffer that simultaneously imparts vibration and includes a buffing pad consisting of lamb's wool.

6) The method of claim 5, wherein in operation the buffing pad of the dual action buffing device creates sufficient friction with the ceramic coating to impart a resulting 9H hardness level to the ceramic coating.

7) The method of claim 1, wherein washing comprises:
a preliminary wash; and,
a secondary wash with a clay bar infused wash solution.

8) The method of claim 1 further comprises providing a mobile, self-contained washing system comprising:
a reverse osmosis (RO) water purification system with an inlet and a discharge,
a multi-media filter operably connected between the RO water purification system inlet and a water source,
an RO water storage tank operably connected to the RO water discharge, and
a booster pump with a suction and discharge coupled between a discharge of the multi-media filter and the inlet of the RO water purification system.

9) The method of claim 6, wherein the mobile, self-contained washing system further includes a valve housing containing one or more water isolation solenoid valves coupled between the outlet of the multi-media filter and the suction of the booster pump.

10) The method of claim 7, wherein the one or more water isolation solenoid valves is configured to secure water flow into the suction of the feed pump when the feed pump is not energized.

11) The method of claim 7, wherein the one or more water isolation solenoid valves is configured to secure water flow into the suction of the feed pump when the RO storage tank is full.

12) A self-contained, mobile washing system, comprising:
one of a suitable sized panel truck and a suitable sized nose enclosed cargo trailer, containing:
a multi-media filter with an inlet and an outlet, the inlet attached to water supply inlet;
a valve enclosure with an inlet and an outlet, the inlet attached to the outlet of the multi-media filter;
a booster pump with a suction and a discharge, the suction connected to the outlet of the valve enclosure;
a reverse osmosis (RO) system with an water inlet, an RO outlet and concentrate outlet, the inlet connected to the discharge of the booster pump;
an RO storage tank with an inlet and an outlet, the inlet connected to the RO system outlet and the outlet to a suction of a high pressure pump;
a washing machine with an inlet and a drain, the inlet connected to the RO system outlet and to the RO storage tank inlet;
a power distribution system delivering power from a power source to the valve enclosure, the booster pump, the high pressure pump, the washing machine; and,
a clothes drier.

13) The system of claim 12, wherein the RO storage tank has a volume of greater than 100 gallons.

14) The system of claim 12, wherein the RO storage tank comprises a level sensor.

15) The system of claim 12, wherein the RO tank comprises a pressure sensor.

16) The system of claim 12, wherein the valve housing encloses a level sensor solenoid valve in series with a shutdown solenoid valve, each of which shuts the outlet from the multi-media filter based on their respective sensor outputs.

17) The system of claim 12, wherein an output pressure of the booster pump ranges between 100 psi and 400 psi.

18) The system of claim 12 further comprising one or more satellite trailers, each satellite trailer containing at least a suitably sized RO water storage tank and a discharge pump for the storage tank.

19) The system of claim 12 further comprising a suitably sized Reverse Osmosis concentrate collection tank.

20) A mobile washing system kit, comprising:
a multi-media filter;
a valve enclosure;
a booster pump with a rated discharge pressure between 100 psi and 400 psi;
a reverse osmosis (RO) system;
an RO storage tank with a capacity greater than 100 gallons;
a high pressure discharge pump;
at least one high pressure nozzle;
a washing machine;
a clothes drier;
a dual action orbital buffing device, and
a power distribution system configured to delivering power from a power source to the valve enclosure, the booster pump, the high pressure pump, the washing machine and a clothes drier.

21) The mobile washing system kit of claim 20 further comprising a water heater configured to heat RO water for the washing machine.

22) The mobile washing system kit of claim 20 further comprising a suitably sized concentrate storage tank.
